(19) United States
(12) Patent Application Publication
(10) Pub. No.: US 2003/0016647 A1
(43) Pub. Date: Jan. 23, 2003

(54) System and method for multipoint to multipoint data communication

(76) Inventor: Kenneth Margon, Oakland, CA (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 10/198,746

(22) Filed: Jul. 19, 2002

Related U.S. Application Data
(63) Continuation-in-part of application No. 09/482,054, filed on Jan. 13, 2000.
(60) Provisional application No. 60/306,159, filed on Jul. 19, 2001.

(51) Int. Cl. H04B 7/216

(52) U.S. Cl. 370/342

(57) ABSTRACT

A system and method is provide for multipoint to multipoint data communication. In an embodiment of the invention, a system comprises a communications medium interconnecting at least one central server and a plurality of communication nodes. The central server transmits information to the nodes via a Forward Channel and the nodes transmit information via a Reverse Channel. Before transmitting, each of the nodes listens (monitors) during an assigned slot of a Clear Channel Assessment interval of the communications cycle to ascertain whether any other node is transmitting. A given node transmits data only when that node determines that the network is clear. The nodes listen in sequential order, eliminating the probability of collisions caused by simultaneous transmissions from nodes. A query channel interval is provided for nodes not assigned a slot within clear channel assessment interval to request a slot. Assigned slots not used by nodes are allocated to other nodes. The data traffic is accordingly aggregated, thus providing efficient utilization.

### CROSS-REFERENCE TO RELATED APPLICATIONS

This present application claims priority to U.S. Provisional Patent Application No. 60/306,159 filed on Jul. 19, 2001, and is a continuation-in-part of U.S. patent application Ser. No. 09/482,054 filed Jan. 13, 2000, both of which are incorporated herein by reference in their entirety.

### BACKGROUND OF THE INVENTION

1. Field of Invention

The present invention relates to data communication, and more particularly, to a system and method for multipoint to multipoint communication.

2. Description of Related Art

In a Local Area Network (LAN), a group of devices is interconnected through a shared network medium. Referring to FIG. 1, a traditional LAN arrangement 100 is shown having a bus topology. LAN 100 is generally referred to as a “Multipoint to Multipoint” system because any one of the multiple devices in the system can send information to one, some, or all of the other multiple devices in the system. Particularly, a shared communication medium 110 operatively interconnects the devices. Communication medium 110 typically comprises optical cable, coax cable, hybrid fiber-coax (HFC) network, wireless media, or any combination thereof. The devices include a central server 120, which performs a plurality of functions including coordination of communications between and among a number “N” of other communication devices 130 also connected to shared communication medium 110 in a manner well understood by those of ordinary skill in the art. Moreover, in such a LAN arrangement, central server 120 acts as a gateway to external networks in addition to managing the LAN access for all connected devices 130. Generally, communication devices 130, also referred to as nodes, are computing devices such as computers or printers. While a bus topology is shown, one of ordinary skill in the art will readily appreciate that other topologies are also commonly in use, including ring topologies, star topologies, and combinations of bus, ring, and star topologies.

It is also well understood that two chief goals in the design of networks, or any other communications system, are speed and reliability. In other words, it is important that units of information (“packets”) placed on the network by any of the devices connected to the network reach their destination quickly and reliably. One of the principal phenomena interfering with achieving these goals occurs when two or more devices connected to the network attempt to use the network at the same time. This can result in a collision of the data which prevents any of the data from reaching its intended destination. As a result, both or all of the devices involved in the collision must retry sending their data at a later time, thereby degrading the speed and efficiency of the network.

There are many arrangements known in the prior art for minimizing the likelihood of collisions and for optimizing recovery when collisions do occur. There remains a need, however, for a system which can minimize the likelihood of collisions and provide for rapid recovery of collisions without incurring too much of penalty in terms of increased system overhead.

### SUMMARY OF THE INVENTION

The present invention is directed to a system and method for efficient multipoint to multipoint communication. The invention overcomes the drawbacks of conventional systems and protocols by dynamically allocating bandwidth based on traffic demands.

In one embodiment, communication is provided in the context of a LAN having a central server and a plurality of nodes. In operation, the central server transmits information in the form of data packets to the nodes via a forward channel of a communication cycle and one of the nodes transmits data packets to one or more of the other nodes and/or the central server in a reverse channel. Before transmitting on the reverse channel, however, each of the nodes listens to (i.e., monitors) the network during a clear channel assessment time slot assigned to it by the central server to ascertain whether any other node is already using the network. Each node having data to transmit transmits that data only after determining that the network is free during the clear channel assessment time. The nodes listen in sequential order, eliminating the probability of collisions caused by simultaneous transmissions from the nodes.

The arrangement thus efficiently and dynamically aggregates data traffic. A node that starts transmitting when its channel assessment indicates the network is not already in use obtains use of the entire reverse channel. If multiple nodes have data to place on the network, access to the reverse channel is allocated according to the needs of those nodes. No node is denied access to the reverse channel for an excessive number of cycles, nor is access to the network wasted on a node that has no data to send. Furthermore, use of the reverse channel is achieved without the overhead of brokering, thereby circumventing any associated delays.

Another feature of the invention is that the order in which the nodes listen to the reverse channel can be rotated periodically. Thus, equal success for transmission on the reverse channel is generally ensured for all nodes.

The foregoing, and other features and advantages of the invention, will be apparent from the following, more particular description of the preferred embodiments of the invention, the accompanying drawings, and the appended claims.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a diagram of typical topology of a conventional multipoint to multipoint communication system;

FIG. 2 is a diagram of a communication cycle in accordance with an embodiment of the invention;

FIG. 3 is a flowchart of a method implemented by an inactive node to gain access to the network according to an embodiment of the invention;

FIG. 4 is a flowchart of a method implemented by a central server to assign CCA slots to inactive nodes according to an embodiment of the invention;

FIG. 5 is a flowchart of operation of an active node according to an embodiment of the invention; and

FIG. 6 is a flowchart of operation of an active node according to another embodiment of the invention.

### DETAILED DESCRIPTION OF PREFERRED EMBODIMENTS

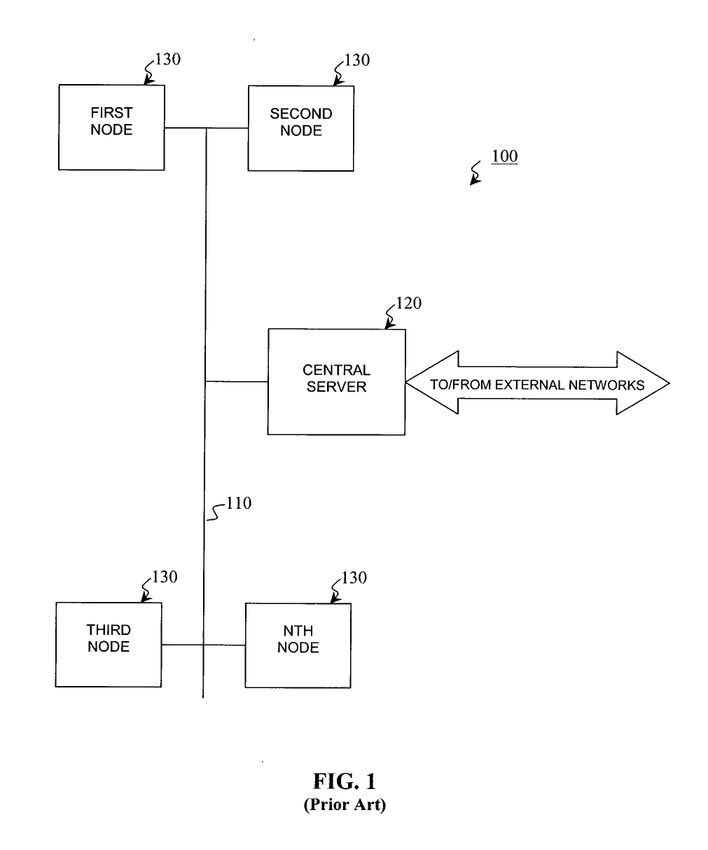

The preferred embodiments of the invention will now be described with reference to FIGS. 1-6, wherein like reference numbers indicate like elements and are discussed herein in the context of implementation of an Internet Protocol Multiple Access (IPMA) system in a local area network. The invention, however, can be practiced to provide information (e.g., digital data, digitized voice) for a wide range of applications. Moreover, the invention can be practiced in other applications and embodiments as would be apparent to one of ordinary skill in the art.

The disclosure of U.S. patent application Ser. No. 09/482,054, filed Jan. 13, 2000, for “System and Method for Single-Point to Fixed-Multipoint Data Communication” is incorporated in its entirety herein by reference.

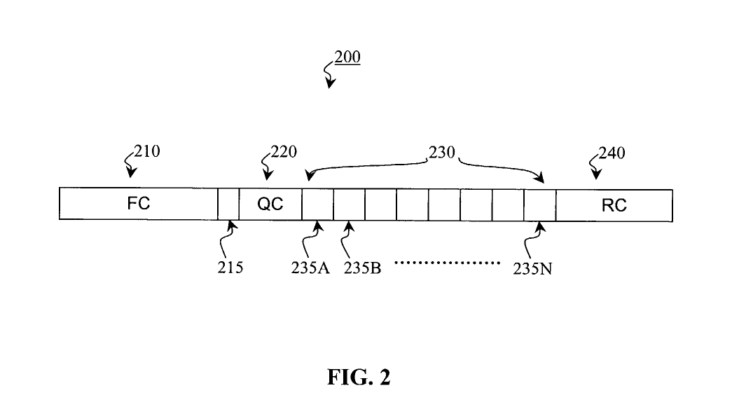

Referring to FIG. 2, a communication cycle 200 is shown according to an embodiment of the invention. Particularly, communication cycle 200 comprises a Forward Channel (FC) interval 210, a Query Channel (QC) interval 220, a Clear Channel Assessment (CCA) interval 230, and a Reverse Channel (RC) interval 240. CCA interval 230 comprises a number “N” of CCA slots 235 each exclusively assigned to a particular node 130. FC interval 210 is initiated by central server 120 and comprises data packets that are pending transmission to one or more nodes 130 during cycle 200. The total width of FC interval 210 can be varied from cycle to cycle depending on the volume of data that is pending. Central server 120 transmits a synchronizing flag 215 at the end of FC interval 210 to synchronize all active nodes 130 throughout the LAN. Accordingly, nodes 130 time the occurrence of their assigned CCA slot 235 relative to the occurrence of synchronizing flag 215. The sizes, i.e., bit length, of the intervals and slots shown in the figure are exemplary only and can be configured to any size as needed.

QC interval 220 is provided to permit those nodes 130 that have data pending for transmission, but which do not currently have a CCA slot 235 assigned to them to notify central server 120 of their presence. As will be described in further detail, upon receiving notification of an inactive node's desire to transmit data, central server 120 can assign a particular CCA slot 235 to that node in order for it to be included in an upcoming communication cycle. The width of QC interval 220 is preferably fixed, but can nevertheless be varied from cycle to cycle if necessary.

At a fixed time after FC interval 210 ends, e.g., upon the expiration of a fixed QC interval 220, CCA interval 230 begins. CCA interval 230 comprises a number of CCA slots 235 assigned to those individual nodes 130 that are presently connected to the network and which have recently been “active” in sending data. Generally, an “active” node is one that has been transmitting data either during the immediately previous cycle or within one or more cycles in a specified plurality of previous cycles, e.g., time limit. In an embodiment of the invention, CCA interval 230 is partitioned into a plurality of CCA slots 235 of equal time duration. In general, each node 130 is dynamically assigned a CCA slot 235 during which it listens to determine whether the network is free. CCA slots 235 follow one another in a serial manner.

RC interval 240 occurs after CCA interval 230 and is the period during which one of nodes 130 exclusively transmits data. Normally, the first node or highest priority node 130 whose CCA slot 235 comes up first in the sequential order of CCA slots starts packet transmission on the reverse channel during the CCA interval 230 itself (if it has data to transmit) and continues through the start time and possibly the duration of RC interval 240. The duration of RC interval 240 can be varied up to a predefined maximum time. The end of RC interval 240 is identified by a special flag byte (not shown). For example, in response to identifying the special flag byte, central server 20 begins transmitting data during the FC interval of the following communications cycle.

All non-transmitting nodes 130 listen to the reverse channel to determine whether a transmitted packet on the network is addressed to them. Only one node 130 is allowed to transmit on the reverse channel of any given communications cycle. The transmitting node 130 can transmit multiple packets to multiple destinations. Multiple packets are preferably delineated using appropriate flags, the implementation of which is apparent to one of ordinary skill in the art. Long data files are preferably split into standard packet sizes and transmitted over multiple cycles. In an embodiment of the invention, there is no acknowledgement mechanism at the transport and/or network layers.

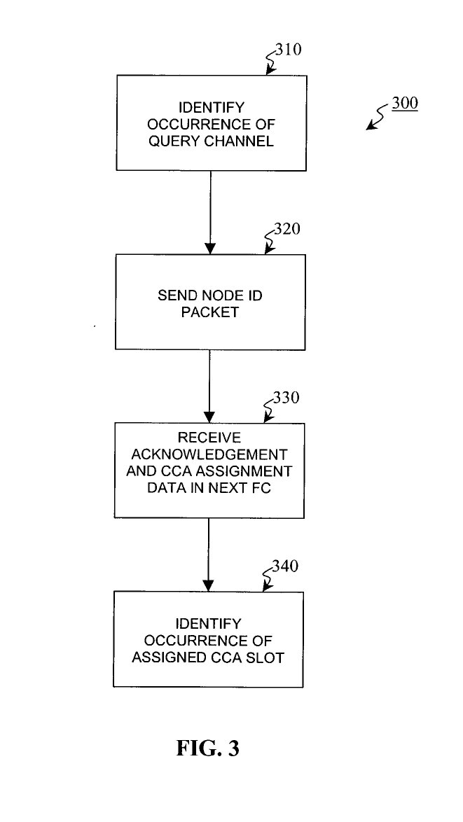

A particular feature of the invention is that only active nodes 130 are allotted CCA slots 235 by central server 120. Nevertheless, those nodes that are not active, which are generally nodes not assigned a particular CCA slot 235 such as a new or previously unconnected node, or any node wishing to log onto (i.e., become active within) the network, can be granted an assigned CCA slot 235 by communicating with central server 120 during QC interval 220. For example, referring to FIG. 3, an inactive node 130 implements a method 300 according to an embodiment of the invention to acquire an assigned CCA slot 235. Particularly, inactive node 130 identifies (step 310) the beginning of QC interval 220. During QC interval 220, inactive node 130 transmits (step 320) a node identification (ID) packet to central server 120. Node ID packet comprises a node ID identifying the name or address of an inactive node that is requesting central server 120 to assign a CCA slot. In turn, the inactive node 130 receives (step 330) an acknowledgement from central server 120 including identification of a particular assigned CCA slot 235 for that node. Typically, such an acknowledgement can be sent by central server 120 to inactive node 130 within the FC interval of the next immediate communication cycle or a future communication cycle. The latter may be necessary if further conventional authentication and security techniques are employed, the implementation of which are apparent to one of ordinary skill in the art, prior to assignment of a CCA slot. Upon receiving an assigned CCA slot 235, the now activated node can identify (step 340) the occurrence of its assigned CCA slot and listen for activity, thereby enabling the node to transmit its data when the reverse channel becomes free.

It is during QC interval 220 that all inactive nodes, which wish to log on to the network, attempt to transmit a node ID packet to central server 120. Because of the possibility of many nodes 130 trying to send node ID packets to server 120 at the time, the probability of collisions, i.e., garbled transmissions, is high. Accordingly, in an embodiment of the invention, conventional collision detection and avoidance methods can be employed, the implementation of which is apparent to one of ordinary skill in the art. For example, a node might simultaneously listen during transmission of a node ID packet to determine when a collision occurs, thereby causing the node to implement a random back off algorithm to retransmit the node ID packet.

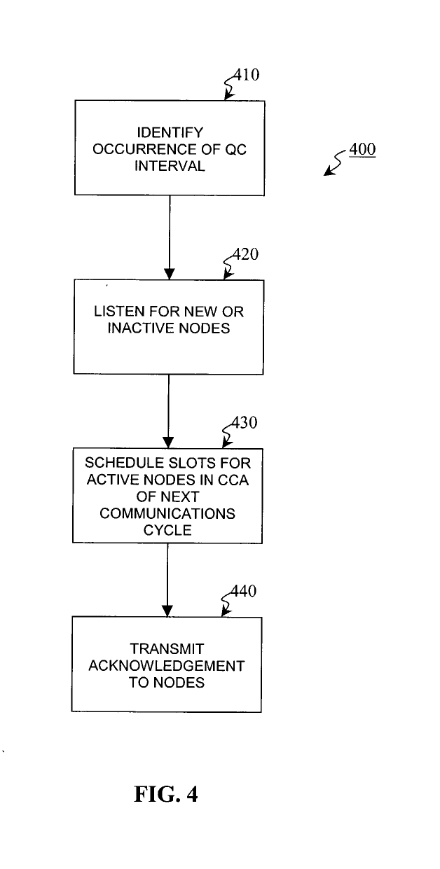

Referring to FIG. 4, a method 400 according to an embodiment of the invention is implemented at central server 120 to assign CCA slots 235 for nodes 130 wishing to communicate on the network. Particularly, central server 120 identifies (step 410) the occurrence of QC interval 220. During this interval, central server 120 listens (step 420) for the transmission of node ID packets. If a node ID packet is received, central server 120 schedules (step 430) a slot for the identified node during a CCA interval 230 of the immediately following or a future communication cycle. During FC interval 210 of the appropriate communication cycle, central server 120 transmits (step 440) an acknowledgement including a schedule of assigned slots 235 to all nodes assigned a CCA slot 235. In another embodiment of the invention, central server 120 transmits an acknowledgement to only those newly activated nodes and any nodes having their assigned CCA slot 235 changed.

According to an embodiment of the invention, an assigned CCA slot 235 can be rescinded from a node, which has not made use of its turn to transmit data during RC interval 240 in a predetermined time limit. Particularly, if central server 120 determines that a particular node 130 has not availed itself when presented with the opportunity to use the network during a particular number of cycles 200, the assignment of CCA slot 235 can be revoked to deactivate the node. For example, central server 120 can send a data packet during the next FC interval 210 comprising a notification that the node no longer has an assigned CCA slot 235. Accordingly, a new schedule of CCA slots 235 can be sent to all remaining active nodes or only those affected by the change in scheduling. If the deactivated node later has data it wishes to place on the network, it notifies central server 120 of its presence during the next appropriate QC interval 220 to request assignment of a new CCA slot 235 in an upcoming CCA interval 230.

Each node 130 listens for traffic on the network during its designated CCA slot 235 and, if there is no traffic (i.e., if some other node with an earlier CCA slot has not already started transmitting), the node can transmit data. More specifically, during CCA interval 230, each node 130 waits until its assigned CCA slot 235 to listen for traffic on the network. A first node 130 (i.e., the node 130 to which the central server 120 has assigned the highest priority CCA slot) listens first. After the expiration of the first CCA slot 235, a second node 310 (i.e., the node 130 to which the central server 120 has assigned the second highest priority CCA slot) listens. Similarly, an “n^{th}” node waits until the beginning of the “n^{th}” CCA slot 235 to listen. A node 130 that has data to send does so only when that node has listened to the network during its designated CCA slot 235 and has ascertained that no other node 130 is transmitting (i.e., a clear channel exists). In an embodiment of the invention, a node 130 begin transmission immediately after determining that the reverse channel is clear during its assigned CCA slot. In other words, transmission occurs during CCA interval 230. In another embodiment, a node 130 begins transmission at the occurrence of the CCA slot assigned to the recipient of the transmission. In another embodiment of the invention, a transmitting node 130 waits for the occurrence of RC interval 240 to begin transmission on the reverse channel.

In the above example, if the first node has no data to send, that node spends its CCA slot 235 listening and carries out no transmission even if the network is clear. The second node starts to listen during its CCA slot 235, and assesses whether or not the network is clear. In this example, the network is clear because the node with the preceding slot 235 did not have any data and no other node (i.e., node which has been assigned a later slot) has had the opportunity to transmit yet. If the second node does not have data to transmit, it listens during its CCA slot 235 without any transmission over in the same fashion as the first node. If, however, the second node does have data to transmit it does so immediately after the node assesses that the network is clear. In accordance with an embodiment of the invention, the second node will transmit data during the time allotted for the then current occurrence of RC interval 240. Once the time for the second CCA slot 235 has expired, nodes with later slots listen in turn. Each will detect that the second node is transmitting data. Accordingly, these later nodes determine that the network is not clear and do not attempt to transmit data during the then current communication cycle.

In order to ensure that all nodes have an equal opportunity to transmit data on the network, the order of the CCA slot assignments can be rotated from cycle to cycle. Otherwise, nodes 130 having slots 235 that come earlier in the order (in the above example, the first and second nodes) would always be able to use the network to the exclusion of nodes having slots coming later in time, and the nodes having later slots would have no opportunity to use the network potentially for many cycles. Assigned CCA slots 235 can be rotated in a round robin fashion for each communication cycle 200. For example, the node that listened last in the immediately prior cycle listens first in the next cycle because its CCA slot 235 is shifted to the beginning of the CCA interval 230. The CCA slots for each of the other nodes are shifted to occur later in time by the duration of one CCA slot. Over several cycles the rotation provides each connected node 130 with an equal opportunity to transmit data first. As would be apparent to one skilled in the art, assignment and the changing of the order for slots 235 can readily be achieved with other algorithms other than that of the round robin scheme implemented above. Equal access to the bandwidth is an important feature for those embodiments that support time sensitive traffic or require small and consistent delays. Moreover, embodiments of the invention can be implemented with other CCA slot structures. For example, one or more nodes can be assigned a predetermined and fixed CCA slot. With such embodiments, certain nodes can be guaranteed priority if a particular application makes it desirable to do so.

In an embodiment of the invention, buffer sizes of active nodes 130 are monitored by central server 120. Particularly, the type of information transmitted may be of importance when voice transmission is valued over other types of data. For example, information transmitted can be divided into hard and soft information. Hard information comprises voice data and soft information comprises data such as internal commands or internet data. In order to prevent a node from consistently occupying the reverse channel with soft information, central server 120 monitors at each active node the size of a buffer containing soft information. If central server 120 determines that a node's buffer of soft information gets backlogged (excessive) then that node's CCA slot priority is switched with a node having a lower priority slot. In other words, higher priority CCA slots (those occurring at the beginning of CCA interval 230) are preferably assigned to nodes transmitting hard information as opposed to soft information. Other nodes transmitting soft information are assigned lower priority CCA slots.

During CCA interval 230, each node listens for traffic on the network to ascertain whether other nodes are transmitting. If a first node, which has data packets to send to any other device on the network, ascertains that none of the other nodes is transmitting, the first node transmits its data packets to their destination(s) within the time allotted and then sends the special flag byte signaling the end of RC interval 240. Because each node listens to all transmissions originating from any other node, every other node detects the transmission of the first node and refrains from transmitting.

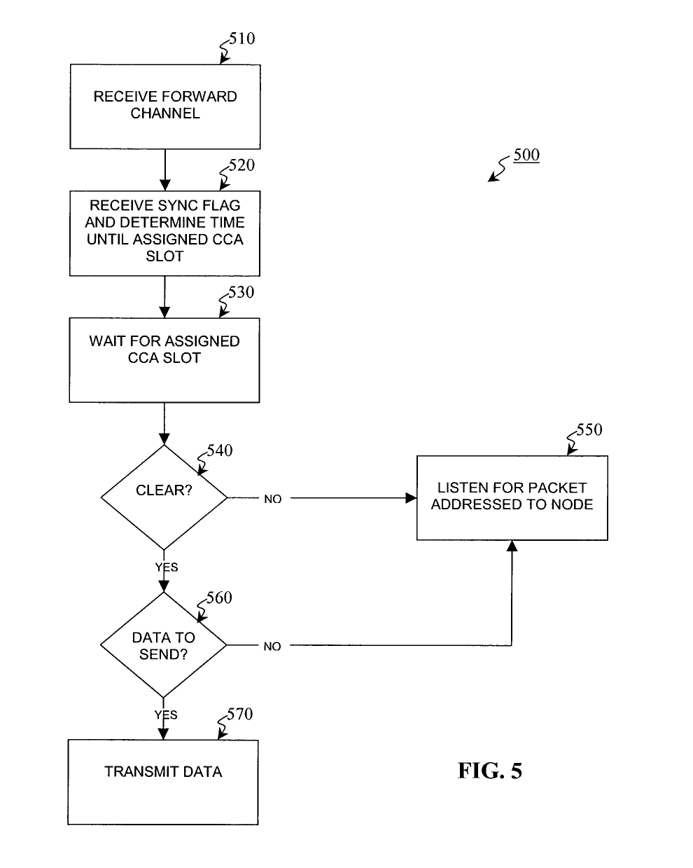

FIG. 5 illustrates a communication method 500 according to an embodiment of the invention implemented by each node 130. In operation, node 130 receives (step 510) data sent by central server 120 during FC interval 210. Upon reception of synchronizing flag 115, node 130 determines (step 520) the time that its assigned CCA slot 235 occurs based on the time of reception of the synchronizing flag and the priority of its assigned CCA slot 235. Based on this determined time, node 130 waits (step 530) for its assigned CCA slot 235. When the appropriate assigned CCA slot occurs, node 130 determines (step 540) if the network is clear. If the network is not clear, node 130 listens (step 550) for packets addressed to it on the reverse channel. If the network is clear, node 130 determines (step 560) if it has data to transmit (step 570) on the reverse channel. If there is no data to transmit, node 130 enters listening mode (step 550).

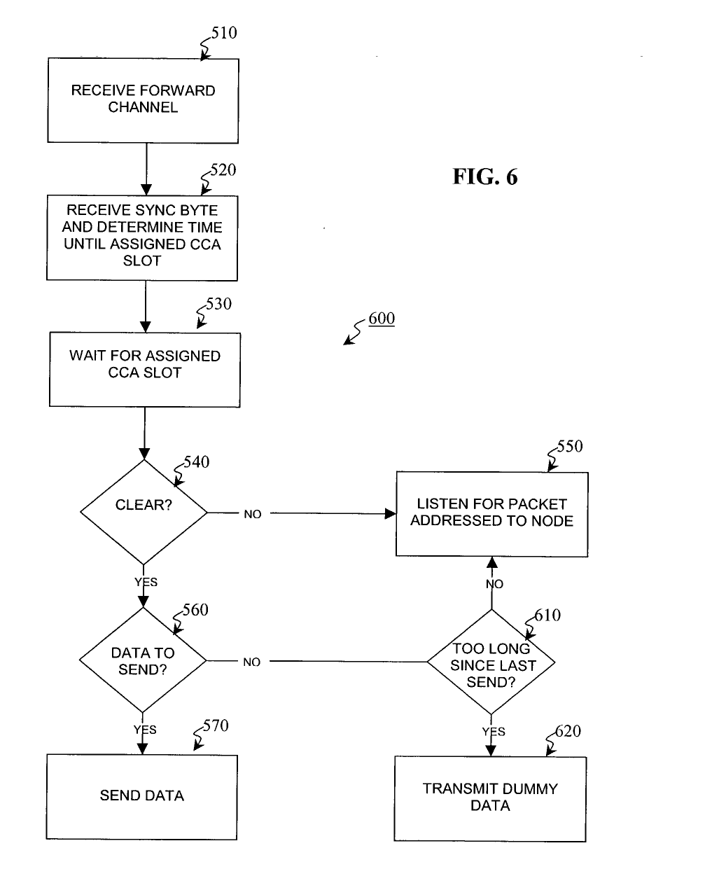

Active nodes need not confirm their presence via transmission of a node ID packet as long as they transmit data periodically. For example, central server 120 keeps track of the availability of RC interval 240 and monitors the transmission of communications between nodes 130. However, if a node has not had data for a predetermined number of cycles but nonetheless wishes to remain connected, it can transmit a dummy packet, e.g., a packet not addressed to any particular node 130. FIG. 6 illustrates a communication method 600 according to an embodiment of the invention to implement a dummy packet. Communication method 600 is identical to communication method 500 except for two additional steps. Particularly, after node 130 determines (step 560) that there is no data to send, the node determines (step 610) whether to maintain its assigned CCA slot, i.e., stay connected. If the node wishes to stay connected, it transmits (step 620) a dummy data packet. Otherwise, node 130 listens (step 550) for packets addressed to it.

In an embodiment of the invention, guard times are provided to accommodate for delays associated with embodiments thereof and to optimize each embodiment to specifications of that embodiment (e.g., extremely low error rate, minimized synchronization time, etc.). Guard times are preferably placed at the beginning and end of the FC interval 210, RC interval 240, and CCA interval 230. Other arrangements, however, can be used to accommodate for the aforementioned and other delays. As noted before, the invention can be practiced, with various applications, topologies, and station designs. Each embodiment will require the compensation for propagation delays associated with transmissions (a function of the distance between the nodes) and delays associated with the circuitry (hardware), processing, and frequency switching of the nodes. It would be apparent to one skilled in the art how to calculate or measure such delay times.

In accordance with the invention, each node determines whether or not to transmit data by monitoring CCA slot 235. In this regard, the embodiments of the invention do not require the central server 120 to broker or provide access to RC interval 240 among the various nodes 130. Accordingly, any propagation delay associated with the brokering is avoided.

Although the invention has been particularly shown and described with reference to several preferred embodiments thereof, it will be understood by those skilled in the art that various changes in form and details may be made therein without departing from the spirit and scope of the invention as defined in the appended claims.

What is claimed is:

1. A system, comprising:
a shared communications medium;
a server connected to said shared communications medium and capable of sending a forward channel signal on said shared communications medium during a predetermined forward channel interval of a communication cycle; and
a plurality of nodes, each of said nodes connected to said shared communications medium and capable of monitoring said forward channel signal, monitoring said shared communications medium for usage during a clear channel assessment slot within a clear channel assessment interval of said communication cycle, and providing a reverse channel signal when said node determines as a result of monitoring said shared communications medium for usage during said clear channel assessment slot that said shared communications medium is clear,
wherein said clear channel assessment interval is partitioned into a number of clear channel assessment slots, each clear channel assessment slot exclusively assigned to one of said nodes.

2. The system of claim 1, wherein said server is capable of receiving said reverse channel signal and wherein each node is capable of receiving said forward channel signal.

3. The system of claim 1, wherein said forward channel signal and said reverse channel signal comprise data packets.

4. The system of claim 1, wherein said forward channel signal includes an address, each node is assigned a unique node address and is capable of accepting information encoded on said forward channel signal when said address of said forward channel matches said assigned unique node address.

5. The system of claim 4, wherein a node address is an Internet Protocol address.

6. The system of claim 1, wherein each of said clear channel assessment slots is of equal duration.

7. The system of claim 6, wherein said server dynamically assigns said clear channel assessment slots to said nodes.

8. The system of claim 7, wherein assignment of said clear channel assessment slots are rotated in a round robin fashion.

9. The system of claim 1, wherein said reverse channel signal is provided during a predetermined reverse channel interval.

10. The system of claim 9, further comprising guard times separating said forward channel interval, said reverse channel interval, and said clear channel assessment interval.

11. The system of claim 1, wherein said server is capable of sending a synchronizing signal upon completion of sending said forward channel signal.

12. The system of claim 11, wherein said synchronizing signal is a synchronizing flag.

13. The system of claim 11, wherein each of said nodes is capable of calculating a time interval between an occurrence of said synchronizing signal and an occurrence of its assigned clear channel assessment slot.

14. The system of claim 9, wherein said server is capable of monitoring said shared communications medium during a query channel interval of said communication cycle.

15. The system of claim 14, wherein said query channel interval occurs after said forward channel interval and prior to said reverse channel interval.

16. The system of claim 14, further comprising:
at least one inactive node, wherein said inactive node is capable of sending a node ID packet during said query channel interval, said node ID packet comprising identification identifying said inactive node.

17. The system of claim 16, wherein said server is capable of assigning a clear channel assessment slot to said inactive node.

18. The system of claim 1, wherein said server is capable of rescinding a clear channel assessment slot for a node, if said server determines that the node is inactive.

19. A method for a multipoint to multipoint communication in a system having a shared communication medium, a server, and a plurality of nodes, the method comprising the steps of:
transmitting from the server a forward channel signal on said shared communication medium;
monitoring said shared communication medium for said forward channel signal at each of the plurality of nodes; and
monitoring said shared communication medium for a reverse channel signal at each of the plurality of nodes, wherein each of the plurality of nodes monitors during a clear channel assessment slot within a clear channel assessment interval,
if said reverse channel is clear during said clear channel assessment slot associated with one of the plurality of nodes and said one of the plurality of nodes has information to send as a reverse channel signal to the server, transmitting a reverse channel signal from said one of the plurality nodes,
wherein said clear channel assessment interval is partitioned into a number of clear channel assessment slots, each clear channel assessment slot exclusively assigned to one of said nodes.

20. The method of claim 19, wherein said forward channel signal wherein each of said clear channel assessment slots is of equal duration.

21. The method of claim 19, further comprising the step of dynamically assigning clear channel assessment slots to each of the plurality of nodes.

22. The method of claim 21, wherein said clear channel assessment slots are assigned in a round robin fashion.

23. The method of claim 19, wherein said forward channel signal is provided during a predetermined forward channel interval and said reverse channel signal is provided during a predetermined reverse channel interval.

24. The method of claim 23, further comprising the step of providing guard times among said forward channel interval, said reverse channel interval, and said clear channel assessment interval.

25. The method of claim 19, further comprising the step of synchronizing the server with the plurality of nodes through a synchronizing signal transmitted by said server.

26. The method of claim 25, further comprising the step of calculating a time interval at each of said nodes between an occurrence of said synchronizing signal and an occurrence of its assigned clear channel assessment slot.

27. The method of claim 19, further comprising the step of monitoring said shared communications medium during a query channel interval at said server.

28. The method of claim 27, further comprising:
sending a node ID packet during said query channel interval from an inactive node, said node ID packet comprising identification identifying said inactive node.

29. The method of claim 28, further comprising the step of assigning a clear channel assessment slot to said inactive node.

30. The method of claim 19, further comprising the step of rescinding a clear channel assessment slot for a node, if said server determines that the node is inactive.

31. A communications cycle format for providing data communications within a multipoint to multipoint communications system comprising a communications medium interconnecting at least one server and a plurality of nodes, the communications cycle format comprising:
a forward channel interval, wherein said forward channel interval designates a time period for sending a forward channel signal from said server;
a clear channel assessment interval, wherein said clear channel assessment interval is partitioned into a number of clear channel assessment slots, each clear channel assessment slot exclusively assigned to one of said nodes, said clear channel assessment slots designating a time period for a node to listen to said communications medium;
a query channel interval, wherein said query channel interval designates a time period for a node not assigned a clear channel assessment slot to request an assignment of a clear channel assessment slot from said server; and
a reverse channel interval, wherein said reverse channel interval designates a time period for sending a reverse channel signal by one of said nodes.

32. The communications cycle format of claim 31, wherein said forward channel interval is variable in duration.

33. The communications cycle format of claim 32, further comprising a synchronization period, wherein said synchronization period designates a time period when said server transmits a synchronization signal, said synchronizing signal designating when said forward channel signal is completed during a communications cycle.

34. The communications cycle format of claim 33, wherein said query channel interval is fixed in duration, said synchronizing signal enabling each of said nodes assigned a clear channel assessment slot to calculate an occurrence of said assigned clear channel assessment slot.

35. The communications cycle format of claim 31, wherein said reverse channel interval is variable in duration.

36. The communications cycle format of claim 31, wherein said query channel interval occurs between said forward channel interval and said clear channel assessment interval.
